(19) United States
(12) Patent Application Publication
(10) Pub. No.: US 2014/0191673 A1
(43) Pub. Date: Jul. 10, 2014

(54) LED DRIVING CIRCUIT HAVING Vcc STABILIZATION CIRCUIT

(71) Applicant: POSCO LED COMPANY LTD., Seongnam-si (KR)

(72) Inventors: Seong Bok Yoon, Seongnam-si (KR); Dae Won Kim, Seongnam-si (KR); Chul Ju Kim, Seongnam-si (KR)

(73) Assignee: POSCO LED COMPANY LTD., Seongnam-si (KR)

(21) Appl. No.: 14/095,337

(22) Filed: Dec. 3, 2013

(30) Foreign Application Priority Data
Jan. 7, 2013 (KR) 10-2013-0001689

(51) Int. Cl. H05B 33/08

(52) U.S. Cl. CPC H05B 33/0809
USPC 315/192

(57) ABSTRACT

An LED driving circuit includes: a bridge rectification circuit configured to receive an AC voltage and perform full-wave rectification on the AC voltage, the bridge rectification circuit including a first LED block, a second LED block, a third LED block, and a fourth LED block each including n LEDs (where n is a positive integer equal to or greater than one); a constant current IC configured to constantly limit a current flowing through the bridge rectification circuit; and a Vcc stabilization circuit connected between the constant current IC and a driving voltage supply node positioned between LEDs constituting one of the first to fourth LED blocks, and configured to stabilize a voltage applied through the bridge rectification circuit and provide the constant current IC with a stabilized driving voltage.

### CROSS-REFERENCE(S) TO RELATED APPLICATION

This application claims priority from and the benefit of Korean Patent Application No. 10-2013-0001689, filed on Jan. 7, 2013, which is hereby incorporated by reference for all purposes as if fully set forth herein.

### BACKGROUND OF THE INVENTION

1. Field

The present invention relates to a light emitting diode (LED) driving circuit having a Vcc stabilization circuit, and more particularly, to an LED driving circuit having a Vcc stabilization circuit capable of supplying a constant current IC with a stable driving voltage (Vcc).

2. Discussion of the Background

A light emitting diode (LED) is a semiconductor element that is made of a material such as gallium (Ga), phosphorus (P), arsenic (As), indium (In), nitrogen (N), aluminum (Al). The LED has a diode characteristic and emits red light, green light, or yellow light when a current flows therethrough. Compared with a bulb or lamp, the LED has a long lifespan, a fast response speed (time until light is emitted after a current flows), and low power consumption. Due to these advantages, the LED has tended to be widely used.

In general, a light emitting element could be driven only with a DC voltage due to the diode characteristic. Therefore, a light emitting device using a conventional light emitting element is restrictive in use and must include a separate circuit, such as SMPS, so as to use an AC voltage that has been currently used at home. Consequently, the circuit of the light emitting device becomes complicated and the manufacturing cost of the light emitting device increases.

In order to solve these problems, much research has been conducted on light emitting elements that can also be driven with an AC voltage by connecting a plurality of light emitting cells in series or in parallel. As a relevant technology, an LED driving circuit has been proposed, which includes a full-wave rectification unit provided in the LED driving circuit and configured to receive an AC voltage and output a rectified voltage.

However, the above-mentioned LED driving circuit has a problem in that a change of the applied voltage may cause an overcurrent and the LED may be damaged. In order to prevent such LED damage resulting from an overcurrent, there have been proposed an LED driving circuit including resistance elements connected in series to prevent the overcurrent, an LED driving circuit including a constant current IC configured to maintain a constant current inside the LED to thereby provide constant characteristics against the varying input voltage, and the like.

Specifically, U.S. Pat. No. 7,863,825 discloses an LED driving circuit including LED groups, which are provided with bridge diodes included in a bridge rectification circuit, and constant current ICs between the LED groups of the bridge diodes.

FIG. 1 is a configuration block diagram of the conventional LED driving circuit described above. As illustrated in FIG. 1, the conventional LED driving circuit includes a bridge circuit and a constant current IC 50. The bride circuit includes first, second, third, and fourth bridge arms 10, 20, 30, and 40 each having two LEDs. The constant current IC 50 controls the current flowing through the bridge circuit to be a constant current. In order to drive the constant current IC 50, a stable IC driving voltage (Vcc) is required. However, the conventional LED driving circuit has a problem in that the LED driving circuit is supplied with time-varying AC voltage, making it impossible to supply the constant current IC 50 with a stable driving voltage (Vcc).

### SUMMARY OF THE INVENTION

The present invention has been made in an effort to solve the above problems, and is directed to provide an LED driving circuit capable of keeping an LED driving current constant.

The present invention is also directed to an LED driving circuit capable of accurately controlling the brightness of an LED by supplying a stabilized driving voltage (Vcc) to a constant current IC keeping the LED driving current constant.

The characteristic configurations for achieving the objects and particular effects of the present invention are as follows.

According to an aspect of the present invention, an LED driving circuit includes: a bridge rectification circuit configured to receive an AC voltage and perform full-wave rectification on the AC voltage, the bridge rectification circuit including a first LED block, a second LED block, a third LED block, and a fourth LED block each including n LEDs (where n is a positive integer equal to or greater than one); a constant current IC configured to constantly limit a current flowing through the bridge rectification circuit; and a Vcc stabilization circuit connected between the constant current IC and a driving voltage supply node positioned between LEDs constituting one of the first to fourth LED blocks, and configured to stabilize a voltage applied through the bridge rectification circuit and provide the constant current IC with a stabilized driving voltage.

The Vcc stabilization circuit may be connected between the constant current IC and the driving voltage supply node positioned between LEDs constituting one of the first to fourth LED blocks.

The position of the driving voltage supply node may be set by at least one factor of an applied AC voltage, a forward-biased voltage of at least one LED positioned before the driving voltage supply node, a voltage drop of the constant current IC itself, a minimum operation voltage of the constant current IC, and required brightness.

When a high driving voltage is required for driving the constant current IC, the driving voltage supply node may be positioned between a first LED and a second LED constituting one of the first to fourth LED blocks, and when an allowable range of rated voltages of the constant current IC is relative low, the driving voltage supply node may be positioned between an (n-1)-th LED and an n-th LED.

The first LED block, the second LED block, the third LED block, and the fourth LED block may be configured such that the second LED block and the third LED block emit light during a positive half-period of the AC voltage, and the first LED block and the fourth LED block emit light during a negative half-period of the AC voltage.

The bridge rectification circuit may include: a first node to which a voltage is applied during the positive half-period of the AC voltage; a third node to which a voltage is applied during the negative half-period of the AC voltage; a second node between the third LED block and the fourth LED block; and a fourth node between the first LED block and the second LED block. The first LED block and the third LED block may be connected in parallel to the first node, with different polarities. The second LED block and the fourth LED block may be connected in parallel to the third node, with different polarities. The first LED block and the second LED block may be connected in series, with different polarities with respect to the fourth node. The third LED block and the fourth LED block may be connected in series, with different polarities with respect to the second node.

The constant current IC may be connected between the second node and the fourth node.

The third LED block may include a fifth node as the driving voltage supply node, and the Vcc stabilization circuit may be connected to the fifth node.

The fourth LED block may include a sixth node as another driving voltage supply node, and the Vcc stabilization circuit may be additionally connected to the sixth node.

The Vcc stabilization circuit may include: a resistor configured to divide the node voltage; a Zener diode connected in series to the resistor and configured to maintain the voltage divided by the resistor at a constant voltage; and a capacitor connected in parallel to the Zener diode and configured to supply the driving voltage to the constant current IC in such a manner that the capacitor is charged when the voltage is equal to or higher than the driving voltage of the constant current IC, and is discharged when the voltage is lower than the driving voltage of the constant current IC.

The Vcc stabilization circuit may further include a diode configured to prevent a current from flowing to the node during discharging of the capacitor.

The first LED block, the second LED block, the third LED block, and the fourth LED block may include at least one single LED.

The first LED block, the second LED block, the third LED block, and the fourth LED block may be an LED array including a plurality of LED groups arranged in series, each of the LED group including at least one LED.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a configuration block diagram of a conventional LED lighting apparatus.

FIG. 2A is a configuration block diagram of an LED driving circuit according to an embodiment of the present invention.

FIG. 2B is a configuration block diagram of an LED driving circuit according to another embodiment of the present invention.

FIG. 3 is a circuit diagram of an LED driving circuit according to an exemplary embodiment of the present invention.

FIG. 4 is a circuit diagram of an LED driving circuit according to another exemplary embodiment of the present invention.

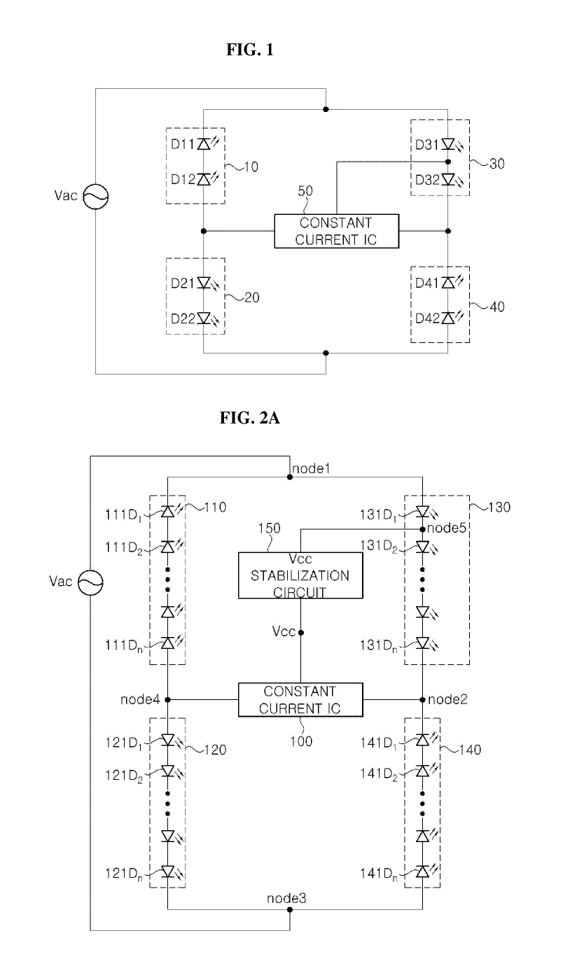

### DETAILED DESCRIPTION OF THE ILLUSTRATED EMBODIMENTS

Exemplary embodiments of the present invention will be described below in detail with reference to the accompanying drawings. These embodiments are provided so that this disclosure will be thorough and complete, and will fully convey the scope of the invention to those skilled in the art. It should be understood that various embodiments of the present invention are different from one another, but are not necessarily exclusive. For example, the particular shape, structure and feature described herein can be embodied in other embodiments, without departing from the spirit and scope of the present invention. Also, it should be understood that the positions or arrangement of individual elements set forth in the respective embodiments can be changed without departing from the spirit and scope of the present invention. Therefore, the following description is not intended to be construed as the restrictive meaning. If appropriately described, the scope of the present invention is defined by the appended claims and equivalents thereof. Throughout the drawings, like reference numerals will be used to refer to like elements.

Hereinafter, in order for a person with ordinary skill in the art to easily carry out the present invention, exemplary embodiments of the present invention will be described in detail with reference to the accompanying drawings.

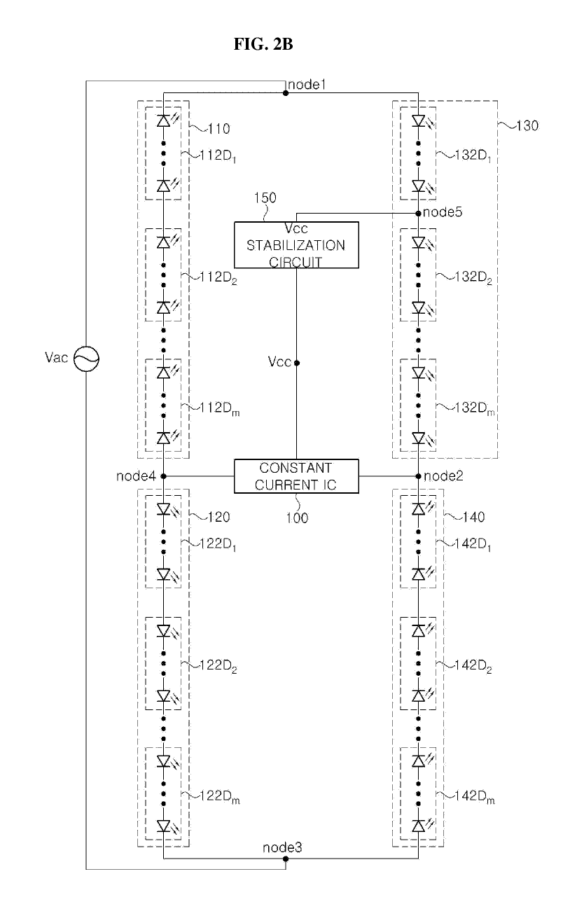

FIG. 2A is a configuration block diagram of an LED driving circuit according to an exemplary embodiment of the present invention. The configuration and function of the LED driving circuit according to the present invention will be described in detail with reference to FIG. 2A.

As illustrated in FIG. 2A, the LED driving circuit according to the present invention may include a bridge rectification circuit, a VCC stabilization circuit 150, and a constant current IC 100.

The bridge rectification circuit according to the present invention is an element configured to perform full-wave rectification on an AC voltage Vac applied thereto, and output a rectified voltage. As opposed to a general bridge rectification circuit including bride diodes, the bridge rectification circuit includes LED blocks 110, 120, 130, and 140. That is, the bridge rectification circuit according to the present invention includes four LED blocks 110, 120, 130, and 140 positioned between nodes of the bridge rectification circuit and configured to perform a rectification function and emit light. Therefore, according to the polarity of the AC voltage Vac, two of the four LED blocks 110, 120, 130, and 140 alternate with the other two and emit light. Each of the LED blocks 110, 120, 130, and 140 constituting the bridge rectification circuit according to the present invention may include n LEDs (where n is a positive integer equal to or greater than one). The number of LEDs constituting each LED block may be variously selected according to requirements. Although it will be assumed in the following description of the embodiment that each of the LED blocks 110, 120, 130, and 140 includes n LEDs (first LED to n-th LED), the assumption is solely for convenience of description and understanding, and does not limit the present invention in any manner.

The configuration of the bridge rectification circuit according to the present invention will now be described in more detail with reference to FIG. 2A. As illustrated, the bridge rectification circuit includes a first node node1, to which a forward-biased voltage is applied during a positive half-period of the AC voltage Vac, and a third node node3, to which a forward-biased voltage is applied during a negative half-period of the AC voltage Vac. That is, the first node node1 and the third node node3 can perform an electrode function. On the other hand, the first LED block 110 and the second LED block 120 are connected in series with different LED polarities. A fourth node node4 is positioned between the first LED block 110 and the second LED block 120. Similarly, the third LED block 130 and the fourth LED block 140 are connected in series with different LED polarities, and a second node node2 is positioned therebetween. The first and second LED blocks 110 and 120, which are connected in series, and the third and fourth LED blocks 130 and 140, which are connected in series, are then connected in parallel between a first nodenode1 and a third node node3.

On the other hand, the constant current IC 100 according to the present invention is connected between the second and fourth nodes node2 and node4 of the bridge rectification circuit and is configured to maintain the current flowing through the bridge rectification circuit at a predetermined constant current value.

As a result of the above-mentioned configuration of the bridge rectification circuit and the constant current IC 100, a forward-biased voltage is applied to the first node node1 during a positive half-period of the AC voltage Vac, so that the third LED block 130 and the second LED block 120 emit light, and a forward-biased voltage is applied to the third node node3 during a negative half-period of the AC voltage Vac, so that the fourth LED block 140 and the first LED block 110 emit light. On the other hand, the LED driving current, which flows at this time, is maintained at a constant current value by the constant current IC 100.

Meanwhile, in order to drive the constant current IC 100, it is necessary to supply a stable DC driving voltage. The LED driving circuit according to the present invention includes a Vcc stabilization circuit 150 configured to supply the constant current IC 100 with a stable DC driving voltage Vcc. The Vcc stabilization circuit 150 is connected to the constant current IC 100 and a driving voltage supply node positioned between a plurality of LEDs, which constitute one of the first LED block 110, the second LED block 120, the third LED block 130, and the fourth LED block 140. The Vcc stabilization circuit 150 is configured to stabilize the node voltage of the driving voltage supply node and supply the constant current IC 100 with a stable driving voltage Vcc. For example, in FIG. 2A, the input terminal of the Vcc stabilization circuit 150 is connected to a fifth node node5 positioned between n LEDs (131D₁ to 131Dₙ) constituting the third LED block 130. The voltage applied to the input terminal of the Vcc stabilization circuit 150 becomes a voltage Vnode5 of the fifth node node5. When an unstabilized driving voltage is supplied from the driving voltage supply node between a plurality of LEDs constituting a specific LED block in this manner, the unstabilized driving voltage is calculated by subtracting a voltage drop, which results from the forward-biased voltage of the LED(s) connected before the driving voltage supply node, from the total voltage. Therefore, the driving voltage supply node is preferably set in an optimal position based on overall consideration of the applied AC voltage, the forward-biased voltage of the LED(s) positioned before the driving voltage supply node node5 among a plurality of LEDs constituting a specific LED block, the driving voltage range/voltage drop amount of the constant current IC 100, the required brightness, and the like. For example, when a high driving voltage is required for driving the constant current IC 100, the driving voltage supply node node5 is preferably positioned near the front (for example, between the first LED and the second LED) among a plurality of LEDs constituting a specific LED block, in order to minimize a voltage drop resulting from the forward-biased voltage of the LED(s). On the other hand, when no high driving voltage is required for driving the constant current IC 100, and when the allowable range of rated voltages of the constant current IC 100 is relatively low, the driving voltage supply node node5 can be positioned near the back (for example, between the (n-1)-th LED and the n-th LED) among a plurality of LEDs constituting a specific LED block.

FIG. 2B is a configuration block diagram of an LED driving circuit according to another embodiment of the present invention. The configuration and function of the LED driving circuit according to another embodiment of the present invention will be described below in detail with reference to FIG. 2B.

In the case of the embodiment illustrated in FIG. 2A, the first to fourth LED blocks 110 to 140 include single LED chips as many as one to n, but the embodiment illustrated in FIG. 2B differs from the embodiment illustrated in FIG. 2A in that the first to fourth LED blocks 110 to 140 include m LED groups (where m is an integer equal to or greater than one). Each of the LED groups includes at least one LED. Therefore, as illustrated in FIG. 2B, the first LED block 110 includes m LED groups 112D₁ to 112Dₘ, each of which includes at least one LED. In addition, the second LED block 120 includes m LED groups 122D₁ to 122Dₘ, each of which includes at least one LED. Likewise, each of the third LED block 130 and the fourth LED block 140 includes m LED groups 132D₁ to 132Dₘ and 142D₁ to 142Dₘ, each of which includes at least one LED.

Since the first to fourth LED blocks 110 to 140 include LED groups, the driving voltage supply node node5, which supplies an unstabilized driving voltage as described above, is positioned between LED groups. Therefore, when the embodiment illustrated in FIG. 2A includes the third LED block 130 with fifteen LEDs and the embodiment illustrated in FIG. 2B includes the third LED block 130 with first to third LED groups, each of which includes five LEDs, the third LED blocks 130 according to the two embodiments include the same number of LEDs; however, there is a difference in that, in the case of the embodiment illustrated in FIG. 2A, the driving voltage supply node node5 can be in a position between the first to fifteenth LEDs, while, in the case of the embodiment illustrated in FIG. 2B, the driving voltage supply node node5 can only be in a position between the first to third LED groups.

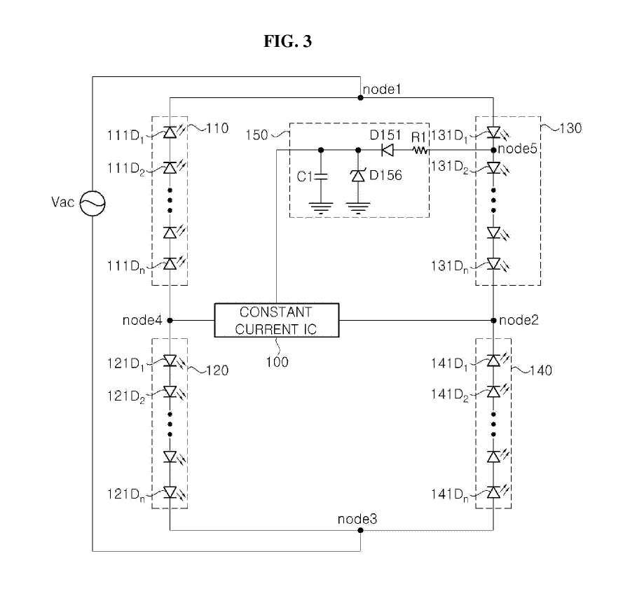

Meanwhile, as described above with reference to FIGS. 2A and 2B, the Vcc stabilization circuit 150 is configured to supply the constant current IC 100 with a DC driving voltage, which is constant regardless of the magnitude and polarity change of the AC voltage Vac. One of various constant voltage supply circuits known in the art can be selected and used as the Vcc stabilization circuit 150. The configuration and function of the Vcc stabilization circuit 150 according to the present invention will be described below in detail with reference to FIG. 3.

FIG. 3 is a circuit diagram of an LED driving circuit according to an embodiment of the present invention. More specifically, FIG. 3 illustrates a specific embodiment for realizing the Vcc stabilization circuit 150 as illustrated in FIGS. 2A and 2B. The Vcc stabilization circuit 150 according to the present invention will now be described in detail with reference to FIG. 3.

As illustrated in FIG. 3, the Vcc stabilization circuit 150 according to the present invention may include a voltage division resistor R1, a reverse current prevention diode D151, a voltage-limiting Zener diode D156, and a charging/discharging capacitor C1.

The voltage division resistor R1 is configured to divide the voltage of the driving voltage supply node node5 and prevent any inflow of overcurrent, thereby protecting the Vcc stabilization circuit 150. The reverse current prevention diode D151 is configured to prevent any flow of current into the voltage division resistor R1 and the driving voltage supply node node5 during discharging of the charging/discharging capacitor C1.

The voltage-limiting Zener diode D156 is configured to control the voltage so that the voltage divided by the voltage division resistor R1, that is, the charging voltage applied to the charging/discharging capacitor C1, is maintained below a predetermined maximum operation voltage of the constant current IC 100.

The charging/discharging capacitor C1 is connected in parallel to the voltage-limiting Zener diode D156 and is configured to supply the constant current IC 100 with the driving voltage in such a manner that the charging/discharging capacitor C1 is charged when the voltage is equal to or higher than the driving voltage of the constant current IC 100, and is discharged when the voltage is lower than the driving voltage of the constant current IC 100.

The operation of the Vcc stabilization circuit 150 according to the present invention, which is configured as described above, will now be described. When the supply of the AC voltage Vac is started, a current flows through the driving voltage supply node node5, the resistor R1, and the reverse current prevention diode D151, and begins to charge the charging/discharging capacitor C1. When the voltage Vcc across the charging/discharging capacitor C1 becomes equal to or higher than a minimum operation voltage (for example, DC 5V) that can drive the constant current IC 100, the constant current IC 100 starts operating.

When the voltage level of the AC voltage Vac gradually rises with time and exceeds a predetermined maximum operation voltage of the constant current IC 100, the voltage-limiting Zener diode D156 limits the voltage applied to the constant current IC 100 to an allowable range of rated voltages.

When the voltage level of the AC voltage Vac gradually decreases with time and the voltage applied to the charging/discharging capacitor C1 drops below the minimum operation voltage, the charging/discharging capacitor C1 starts discharging and supplies the constant current IC 100 with driving voltage. The supply of the driving voltage to the constant current IC 100 by the charging/discharging capacitor C1 continues until the voltage applied to the charging/discharging capacitor C1 becomes equal to or higher than the minimum operation voltage of the constant current IC 100.

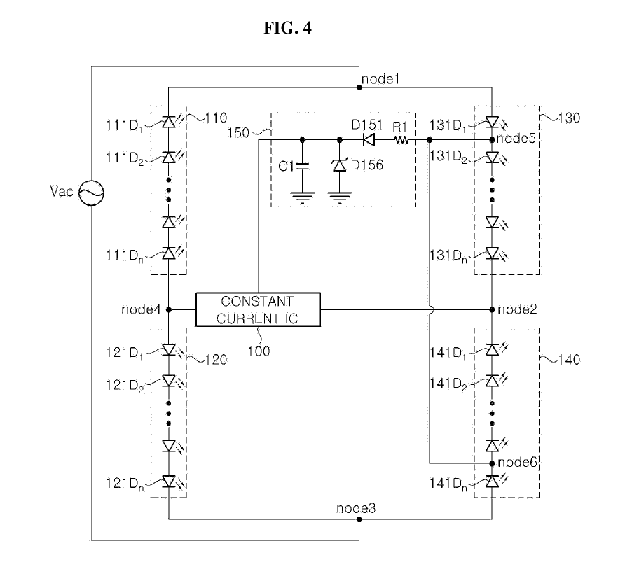

FIG. 4 is a circuit diagram of an LED driving circuit according to another embodiment of the present invention. The configuration and function of the LED driving circuit according to another embodiment of the present invention will now be described with reference to FIG. 4. Since the LED driving circuit illustrated in FIG. 4 is similar to the LED driving circuit illustrated in FIG. 3, a following description will be focused on the differences therebetween and a redundant description will be omitted.

The Vcc stabilization circuit 150 included in the LED driving circuit according to another embodiment of the present invention is configured to receive an additional voltage from a sixth node node6 positioned at an arbitrary position between the first LED 141D₁ and the n-th LED 141Dₙ constituting the fourth LED block 140. As a result of this configuration, the Vcc stabilization circuit 150 according to the present invention can be supplied with a forward-biased voltage through the sixth node node6 even during the negative half-period of the AC voltage Vac. Therefore, it can be expected to reduce the capacity of the charging/discharging capacitor included in the Vcc stabilization circuit 150.

As described above, according to the present invention, the supply of the stabilized constant current IC driving voltage Vcc can solve the problem of uneven power consumption resulting from the supply of the unstable constant current IC driving voltage.

In addition, according to the present invention, when a reference voltage (Vref) provided to a comparator (OP amp) is generated using the driving voltage supplied to the constant current IC, Vcc is stabilized and accurate control is enabled with the use of the reference voltage.

Moreover, according to the present invention, it is possible to enhance EMI problems (radiation, conduction, and the like) resulting from noise of Vcc.

While the invention has been shown and described with reference to certain exemplary embodiments thereof, it will be understood by those skilled in the art that various changes in form and details may be made therein without departing from the spirit and scope of the invention as defined by the appended claims.

Therefore, the scope of the invention is defined not by the detailed description of the invention but by the appended claims, and all equivalents or modifications of the claims will be construed as being included in the present invention.

What is claimed is:

1. An LED driving circuit comprising:
a bridge rectification circuit configured to receive an AC voltage and perform full-wave rectification on the AC voltage, the bridge rectification circuit comprising a first LED block, a second LED block, a third LED block, and a fourth LED block each including n LEDs (where n is a positive integer equal to or greater than one);
a constant current IC configured to constantly limit a current flowing through the bridge rectification circuit; and
a Vcc stabilization circuit connected between the constant current IC and a driving voltage supply node positioned between LEDs of one of the first to fourth LED blocks, and configured to stabilize a voltage applied through the bridge rectification circuit and provide the constant current IC with a stabilized driving voltage.

2. The LED driving circuit of claim 1, wherein the position of the driving voltage supply node is set by at least one of an applied AC voltage, a forward-biased voltage of at least one LED positioned before the driving voltage supply node, a voltage drop of the constant current IC itself, a minimum operation voltage of the constant current IC, and a required brightness.

3. The LED driving circuit of claim 2, wherein,
when a high driving voltage is required for driving the constant current IC, the driving voltage supply node is positioned between a first LED and a second LED of one of the first to fourth LED blocks, and
when an allowable range of rated voltages of the constant current IC is relatively low, the driving voltage supply node is positioned between an (n-1)-th LED and an n-th LED.

4. The LED driving circuit of claim 1, wherein the first LED block, the second LED block, the third LED block, and the fourth LED block are configured such that the second LED block and the third LED block emit light during a positive half-period of the AC voltage, and the first LED block and the fourth LED block emit light during a negative half-period of the AC voltage.

5. The LED driving circuit of claim 4, wherein the bridge rectification circuit comprises:
a first node to which a voltage is applied during the positive half-period of the AC voltage;
a third node to which a voltage is applied during the negative half-period of the AC voltage;
a second node between the third LED block and the fourth LED block; and
a fourth node between the first LED block and the second LED block, wherein, the first LED block and the third LED block are connected in parallel to the first node, with different polarities,
the second LED block and the fourth LED block are connected in parallel to the third node, with different polarities,
the first LED block and the second LED block are connected in series, with different polarities with respect to the fourth node, and
the third LED block and the fourth LED block are connected in series, with different polarities with respect to the second node.

6. The LED driving circuit of claim 5, wherein the constant current IC is connected between the second node and the fourth node.

7. The LED driving circuit of claim 5, wherein the third LED block comprises a fifth node as the driving voltage supply node, and the Vcc stabilization circuit is connected to the fifth node.

8. The LED driving circuit of claim 7, wherein the fourth LED block comprises a sixth node as another driving voltage supply node, and the Vcc stabilization circuit is additionally connected to the sixth node.

9. The LED driving circuit of claim 1, wherein the Vcc stabilization circuit comprises:
a resistor configured to divide the node voltage;
a Zener diode connected in series to the resistor and configured to maintain the voltage divided by the resistor at a constant voltage; and
a capacitor connected in parallel to the Zener diode and configured to supply the driving voltage to the constant current IC in such a manner that the capacitor is charged when the voltage is equal to or higher than the driving voltage of the constant current IC, and is discharged when the voltage is lower than the driving voltage of the constant current IC.

10. The LED driving circuit of claim 9, wherein the Vcc stabilization circuit further comprises a diode configured to prevent a current from flowing to the node during discharging of the capacitor.

11. The LED driving circuit of claim 1, wherein the first LED block, the second LED block, the third LED block, and the fourth LED block comprise at least one LED.

12. The LED driving circuit of claim 1, wherein the first LED block, the second LED block, the third LED block, and the fourth LED block are an LED array including a plurality of LED groups arranged in series, each of the LED group comprising at least one LED.
